(19) United States
(12) Patent Application Publication
(10) Pub. No.: US 2020/0352198 A1
(43) Pub. Date: Nov. 12, 2020

(54) Pressure Treated Coconut Toddy Drink

(71) Applicant: ECOCO ECOVENTURES LIMITED LIABILITY COMPANY, Murphy, TX (US)

(72) Inventors: George P. Mathew, Brooklyn, NY (US); Sivaraj Palaniswany, Austin, TX (US); Meyyappan Raman, Christchurch (NZ); Arvinth Muthuchamy, Murphy, TX (US)

(21) Appl. No.: 16/406,264

(22) Filed: May 8, 2019

(51) Int. Cl. A23L 3/015; C12H 1/16; A23L 2/02

(52) U.S. Cl. CPC A23L 3/0155; A23V 2002/00; A23L 2/02; C12H 1/16

(57) ABSTRACT

A pressure-treated, partially fermented palm sap beverage is disclosed that has an alcohol content of about 4-6%, a total yeast and mold count of no more than about 50 CFU/g, a shelf-life of at least 9 days at about 20° C. and the characteristic flavor of freshly harvested toddy.

### FIELD OF THE EMBODIMENTS

This invention pertains to a partially fermented palm sap drink and methods of making same.

### BACKGROUND OF THE EMBODIMENTS

Palm wine also called kallu in Malayalam and Tamil, palm toddy, or simply toddy, is an alcoholic beverage created from the sap of various species of palm tree such as the palmyra, date palms and coconut palms. Traditionally, the sap is harvested in the evening by slicing a layer of the palm's inflorescence and hanging the open end on an earthen pot overnight to allow the palm's sap to drip from the stem into the pot. The following day, the collected sap starts to undergo fermentation as the ambient temperature increases. The resulting toddy is a sweet tasting, cloudy white liquid containing up to 6-8% alcohol. Toddy needs to be drunk soon after partial fermentation (about 5-6% alcohol content) by the end of day, as it becomes more and more sour and acidic with time. It is the toddy's short shelf life that is undoubtedly the biggest impediment preventing the wide spread commercialization and export of the toddy drink. Accordingly, there is a need in the art for methods of extending the shelf life of toddy without compromising its characteristic flavor, color or texture.

Examples of related art are described below:

U.S. Pat. No. 7,220,381 discloses a product carrier for use in pressure processing substances that is substantially fluidically closed, and is insulated, to prevent heat transfer from the product being treated to the cooler wall of the pressure vessel. The insulating material has compression heating properties, such that as the product is pressurized, the temperature of the insulation increases as does the temperature of the product and pressure media, thereby helping to prevent heat transfer from the product to the surrounding media and pressure vessel wall.

U.S. Pat. No. 5,232,726 discloses fresh squeezed single-strength citrus juice or other juices that are homogenized under an ultra-high pressure of about 15,000 psi. The ultra-high pressure homogenized juices exhibit an increased shelf life and decreased microbiological activity compared to juice homogenized under conventional pressures.

The published U.S. Patent Application No. 2013/0052312 teaches methods of preparing a non-alcoholic toddy drink from a toddy juice collected from a stalk of a coconut, a stalk of a palm tree, or coconut water by irradiating or filtering the toddy juice to deactivate yeast fermentation without refrigeration, pasteurization, or chemical additives.

The published U.S. Patent Application No. 2014/0212544 discloses a beverage using coconut juice as a sole fluid base supplying water, fortified with one or more nutrients such as vitamins and minerals. The beverage may be provided in concentrate form by removing some or all of the water present in natural coconut juice. The concentrate may be reconstituted by adding water obtained from a source other than the original coconut juice. The beverage or the concentrate may include non-nutritive components such as carbonation, sweeteners, preservatives, coloring agents, artificial flavors and fragrances.

The published European Patent Application No. EP0894440 discloses a process for sterilization of a liquid in a continuous system comprising a series of steps. First the liquid is continuously pumped into a pressurized system. Second, the pressure on the liquid is increased in a first pressurization stage. Next, the liquid is increased in pressure in a second pressurization stage. Fourth, the liquid is held at an elevated pressure for a predetermined period of time to kill off microorganisms within the liquid. The liquid is then rapidly depressurized to fracture microorganisms within the liquid. The apparatus for producing this process includes a continuous liquid treatment system with a pump, a first stage intensifier, a surge drum, a second stage intensifier, a pressure receiver and a pressure reducer. A particulate treatment system may also be included which comprises a pressure receiver, an intensifier, and a recoverer for blending a particulate component with the liquid component.

The published European Patent Application No. EP1855553 discloses a method of pressure treating a bioactive composition comprising at least one bioactive component to prevent the growth of at least one unwanted microorganism while retaining a desired level activity of the at least one bioactive component. The bioactive component is selected from one or more proteins protein hydrolysates, one or more lipids or lipid hydrolysates, one or more carbohydrates, one or more probiotic factors, or mixtures thereof. The pressure treatment is at a predetermined pressure from about 350 to 1000 MPa.

The published British Patent Application No. GB1129746 discloses beverages that are preserved by irradiation with ionizing y-radiation and are also subjected to a physical, physico-chemical and/or chemical treatment, the dose of γ-radiation used being below one half of that which would be required to sterilize a beverage when using γ-radiation alone.

The PCT International Application No. WO2004032655 teaches a method of pressure treating foods containing cultures, wherein the pressure treatments are performed under such conditions such that cultures survive while the growth of spoilage microflora is reduced, delayed, prevented or eliminated. Foods treated according to the invention include cultural dairy foods (such as yoghurts), fruit and vegetable juices and other dairy foods (such as cheese).

The PCT International Application No. WO2004093573 teaches a multi-stage system and method for pasteurizing food products that includes a first processing unit configured to receive the food product and apply an amount of non-thermal energy treatment to the food product which is effective to inactivate one or more key enzymes. A second processing unit is configured to receive the food product from the first processing unit and reduces the population of potentially harmful microorganisms to a level that is not harmful to consumers of the food product. In one alternative embodiment, the second processing unit comprises a concentration unit which removes water from the food product to produce a concentrated form of the product. The first processing unit may, for example, comprise a high voltage arc discharge unit, a non-thermal pulsed electric field unit, an oscillating magnetic field unit, or an ultrasonic unit.

The PCT International Application No. WO1999038394 discloses methods for preparing juices having an extended shelf-life without the need for pasteurization. Such methods employ ultra-high pressure (UHP) to substantially inactivate microorganisms associated with juices. The resulting juice products retain many of the preferred fresh juice characteristics such as taste, nutrition, texture and color, characteristics that may be destroyed or diminished by thermal processing or pasteurization

The PCT International Application No. WO2018067203 discloses the preparation of a shelf stable coconut water concentrate along with a method of producing a ready to drink fountain coconut water beverage from the coconut water concentrate. The resulting ready to consume fountain drink is made solely from freshly sourced or processed coconut water without adding other fruit juice, additives, enzymes, flavorings, colorings or preservatives. A coconut water stock is concentrated by an evaporation process to obtain a coconut water concentrate of at least 70° Brix having a water activity of 0.7% or below.

The coconut water concentrate is microbiologically stable at room temperature without the addition of additives or preservatives and does not require refrigeration. Water or other liquids are added to the coconut water concentrate at a ratio of between 20 to 30 parts water to 1-part stable coconut water concentrate, to form a variety of coconut water fountain drinks.

None of the art described above art addresses all the issues that the present invention does. For example, none of the art teaches arresting a partially fermented toddy using pressures up to 80,000 psi (approximately 4500-6200 bar) without heat to produce a toddy containing about 5% alcohol content that has the same characteristic flavor as freshly harvested toddy.

### SUMMARY OF THE EMBODIMENTS

In a first aspect, a pressure-treated, partially fermented palm sap beverage is disclosed.

In certain embodiments of the first aspect, the palm sap beverage is stable for at least 9 days at about 20° C.

In certain embodiments of the first aspect, the palm sap beverage comprises a total yeast and mold count of less than about 50 CFU/g.

In certain embodiments of the first aspect, the palm sap beverage comprises an alcohol content of about 0-10%.

In certain embodiments of the first aspect, the palm sap beverage comprises an alcohol content of about 4-6%.

In certain embodiments of the first aspect, the palm sap beverage comprises flower sap from the coconut palm.

In certain embodiments of the first aspect, wherein the palm sap beverage is subjected to a first pressure treatment of about 4500-6200 Bar at about 15° C.

In certain embodiments of the first aspect, the first pressure-treatment lasts for about 180 seconds.

In certain embodiments of the first aspect, the palm sap is incubated at about 4-6° C. prior to a second pressure treatment of about 4500-6200 Bar.

In certain embodiments of the first aspect, the palm sap is incubated at about 20° C. prior to a second pressure treatment of about 4500-6200 Bar.

In certain embodiments of the first aspect, the palm sap is partially fermented for about 4-6 hours at about 20° C. prior to the first pressure treatment.

In certain embodiments of the first aspect, the palm sap is not irradiated and/or pasteurized.

In a second aspect, a beverage is disclosed consisting of a partially fermented palm sap having an alcohol content of about 4-6% and a total yeast and mold count of less than about 50 CFU/g.

In a third aspect, a method for making a palm sap beverage comprising subjecting a partially fermented palm sap to a pressure treatment of more than about 4500-6200 Bar.

In certain embodiments of the third aspect, the pressure treatment lasts about 180 seconds.

In certain embodiments of the third aspect, the partially fermented palm sap is incubated at about 20° C. after the pressure treatment.

In certain embodiments of the third aspect, the pressure treated partially fermented palm sap is subjected to a second pressure treatment of about 4500-6200 Bar at about 20° C.

In certain embodiments of the third aspect, the second pressure treatment lasts about 180 seconds.

In certain embodiments of the third aspect, the partially fermented palm sap has an alcohol content of about 4-6%.

In certain embodiments of the third aspect, the partially fermented palm sap comprises a total yeast and mold count of less than about 50 CFU/g.

In certain embodiments of the third aspect, the palm sap beverage is stable for at least 9 days at about 20° C.

### BRIEF DESCRIPTION OF THE DRAWINGS

FIG. 1 depicts an exemplary Toddy production process.

FIG. 2A and FIG. 2B show exemplary depictions of yeast cultured on a Dichloran Rose Bengal Chloramphenicol Agar plate.

FIG. 3 shows an exemplary APC count (FIG. 3A) and an exemplary yeast count (FIG. 3B) in samples 1, 2 and 4 on Day 2 and Day 9.

### DESCRIPTION OF THE PREFERRED EMBODIMENTS

The preferred embodiments of the present invention will now be described with reference to the drawings. Identical elements in the various figures are identified with the same reference numerals. Such embodiments are provided by way of explanation of the present invention, which is not intended to be limited thereto. Those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

When a range of values is listed herein, it is intended to encompass each value and sub-range within that range. For example, “1-5 ng” is intended to encompass 1 ng, 2 ng, 3 ng, 4 ng, 5 ng, 1-2 ng, 1-3 ng, 1-4 ng, 1-5 ng, 2-3 ng, 2-4 ng, 2-5 ng, 3-4 ng, 3-5 ng, and 4-5 ng.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The terms “toddy” or “palm wine” refer to alcoholic palm sap beverages made from the fermentation of a sugary palm sap in the presence of yeast, temperature and processing conditions. These cloudy, whitish beverages are often consumed in parts of Africa, South India, Myanmar and Mexico in a variety of flavors varying from sweet unfermented to sour, fermented and vinegary depending on the length of fermentation. A major limitation to its more widespread distribution remains the short shelf life of the drink which is limited to about 24 hours.

As used herein, the term “sap” refers to the sap of a palm plant including, but not limited to, the coconut palm, oil palm, wild date palm, nipa palm, raphia palm and kithul palm.

In certain embodiments, the sap can be collected by slicing off the top of a palm plant's flower inflorescence, for example, from the coconut palm (Cocus neusifera).

In certain embodiments, the sap can be collected from the trunk of a palm tree, for example, raphia (Raphia hookeri or R. vinifera) or the oil palm (Elaeis guineense). In certain embodiments, the sap is collected by tapping the palm. This involves making a small incision in the bark of the palm, about 15 cm from the top of the trunk. A clean gourd is tied around the tree to collect the sap, which runs into it. The sap is collected each day and should be consumed within about 5-12 hours of collection. Fresh palm juice is a sweet, clear, colorless juice containing about 10-12 percent sugar. In certain embodiments, the sap is collected by felling the palm tree and boring a hole into the trunk. Unlike sap, coconut water is harvested from the coconut fruit.

The process of sap fermentation is an alcoholic fermentation of the sugars in the sap to produce alcohol and carbon dioxide gas. The extracted sap is sweet. After collection it undergoes a rapid natural fermentation to produce alcohol. The shelf life of the product is very short—only one day—after which the fermented sap becomes acidic from the accumulation of acetic acid.

The sap can be not heated. It is an excellent substrate for microbial growth. It is therefore essential that proper hygienic collection procedures are followed to prevent contaminating bacteria from competing with the yeast and producing acid instead of alcohol. Fermentation starts soon after the sap is collected and within an hour or two becomes reasonably high in alcohol (up to about 4%). If allowed to continue to ferment for more than a day, it starts turning into vinegar.

As used herein, the term “partially fermented” palm sap beverage refers to the fermentation of palm sap for about 0.5, 1, 2, 3, 4, 5, 6, 7, 8, 9, or 10 hours at about 20° C.

In certain embodiments, a “partially fermented” palm sap beverage contains about 1, 2, 3, 4, 5, 6, 7, 8, 9, 10, 11 or 12% alcohol.

In certain embodiments, a “partially fermented” palm sap beverage contains the alcohol content of about 5, 10, 15, 20, 25, 30, 35, 40, 45, 50, 55, 60, 65, 70, 75, 80, 85, 90, 95 or 99% of the fully fermented palm sap.

In certain embodiments, a “partially fermented” palm sap beverage contains less than about 1000, less than about 900, less than about 800, less than about 700, less than about 600, less than about 500, less than about 400, less than about 400, less than about 300, less than about 200, less than about 100, less than about 90, less than about 80, less than about 70, less than about 60, less than about 50, less than about 40, less than about 30, less than about 20 or less than about 10 CFU/g.

In certain embodiments, a “partially fermented” palm sap beverage contains about 1000, about 900, about 800, about 700, about 600, about 500, about 400, about 400, about 300, about 200, about 100, about 90, about 80, about 70, about 60, about 50, about 40, about 30, about 20 or about 10 CFU/g.

In certain embodiments, a “partially fermented” palm sap beverage contains about 1-1000, about 1-900, about 1-800, about 1-700, about 1-600, about 1-500, about 1-400, about 1-400, about 1-300, about 1-200, about 1-100, about 1-90, about 1-80, about 1-70, about 1-60, about 1-50, about 1-40, about 1-30, about 1-20 or about 1-10 CFU/g.

Once the alcohol content of the partially fermented sap reaches about 4, about 5 or about 6% alcohol, fermentation of the sap is interrupted by subjecting the sap to very high-pressure processing (HPP). High Pressure Processing (HPP) is a technique by which partially fermented sap is introduced into a vessel and subjected to a high level of hydrostatic pressure transmitted by water.

In certain embodiments, the partially fermented sap is pressure treated after about 1, 2, 3, 4, 5, 6, 7, 8 9 or 10 hours.

In certain embodiments, the partially fermented sap is pressure treated at about 4, 5, 6, 7, 8, 9, 10, 12, 13, 14, 15, 16, 17, 18, 19 or 20 degrees Celsius.

In certain embodiments, the partially fermented sap is pressure treated after about 1, 2, 3, 4, 5, 6, 7,8 9 or 10 hours at about 4, 5, 6, 7, 8, 9, 10, 12, 13, 14, 15, 16, 17, 18, 19 or 20 degrees Celsius.

In certain embodiments, the partially fermented sap is pressure treated after about 1, 2, 3, 4, 5, 6, 7, 8 9 or 10 hours at about 20° C.

In certain embodiments, a substantially non-alcoholic sap is made wherein the fermentation does not produce more than about 0-1% alcohol production to occur.

In certain embodiments, the collected sap is not fermented. In certain embodiments, the collected sap contains about 0% alcohol.

In certain embodiments, the partially fermented sap is treated with very high pressure in a process known as pascalization, bridgmanization, high pressure processing (HPP) or high hydrostatic pressure (HHP) processing to inactivate microorganisms responsible for the fermentation of the palm sap.

In certain embodiments, the partially fermented sap is sealed and placed into a steel compartment containing a liquid, often water, and pumps are used to create pressure. The pumps may apply pressure constantly or intermittently. The application of high hydrostatic pressures (HHP) kills many microorganisms except spores.

In certain embodiments, the collected sap is pressure treated at a constant temperature of about 4, 5, 6, 7, 8, 9, 10, 12, 13, 14, 15, 16, 17, 18, 19 or 20 degrees Celsius.

In certain embodiments, the partially fermented sap is subjected to a high pressure of at least about 4500, about 4600, about 4700, about 4800, about 4900, about 5000, about 5100, about 5200, about 5300, about 5400, about 5500, about 5600, about 5700, about 5800, about 5900, about 6000, about 6100 or about 6200 Bar.

In certain embodiments, the partially fermented sap is subjected to a high pressure of about 4500-6200 Bar. In certain embodiments, the collected sap is maintained at a constant temperature of about 4, 5, 6, 7, 8, 9, 10, 12, 13, 14, 15, 16, 17, 18, 19 or 20 degrees Celsius.

In certain embodiments, the collected sap is maintained at a constant temperature of about 20° C.

In certain embodiments, the partially fermented sap is subjected to the high pressure for about 30, 60, 90, 120, 150 or 180 seconds.

In certain embodiments, the amount of yeast in the pressure-treated partially fermented sap is reduced by about 10, 20, 30, 40, 50, 60, 70, 80, 80, 90 or 95%.

In certain embodiments, a flavor, e.g. a fruit juice flavor, is added to the pressure-treated partially fermented sap including, but not limited to, strawberry, mango, apple, and/or banana. In certain embodiments, the pressure-treated partially fermented palm sap is fortified with minerals and/or vitamins.

In certain embodiments, the pressure-treated partially fermented sap has a pH of about 2, 3, 4 or 5. In certain embodiments, the pressure-treated partially fermented sap has a pH of about 3.26.

In certain embodiments, the pressure-treated partially fermented sap maintains good flavor and palatability for about 40 days at a storage temperature of about 4° C.

In certain embodiments, the pressure-treated partially fermented sap can be stored at about 4, 5, 6, 7, 8, 9, 10, 12, 13, 14, 15, 16, 17, 18, 19 or 20 degrees Celsius without adversely affecting taste or any alteration of alcohol content or amount of yeast.

In certain embodiments, the pressure-treated partially fermented sap can be stored for about 1, 2, 3, 4, 5, 6, 7, 8, 9, 10, 12, 13, 14, 15, 16, 17, 18, 19, 20, 21, 22, 23, 24, 25, 26, 27, 28, 29, 30, 31, 32, 33, 34, 35, 36, 37, 38, 39 or 40 days or more without adversely affecting taste or any alteration of alcohol content or amount of yeast.

In certain embodiments, the pressure-treated partially fermented sap can be stored at about 4° C. for 1, 2, 3, 4, 5, 6, 7, 8, 9, 10, 12, 13, 14, 15, 16, 17, 18, 19, 20, 21, 22, 23, 24, 25, 26, 27, 28, 29, 30, 31, 32, 33, 34, 35, 36, 37, 38, 39 or 40 days or more without adversely affecting taste or any alteration of alcohol content or amount of yeast.

In certain embodiments, the pressure-treated partially fermented sap does not contain any preservatives.

In certain embodiments, the pressure-treated partially fermented sap can be filtered to remove bacterial spores.

In certain embodiments, the pressure-treated partially fermented sap is not treated with heat or pasteurized.

Without being held to any theory, it is believed yeast spores may survive the first pressure treatment and that after a period of incubation about 4, 5, 6, 7, 8, 9, 10, 12, 13, 14, 15, 16, 17, 18, 19 or 20 degrees Celsius for about 1, 2, 3, 4, 5, 6, 7, 8, 9 or 10 hours to allow for spore germination, a second pressure treatment may be required to further eliminate yeast.

Without being held to any theory, it is believed yeast spores may survive the first pressure treatment and that after a period of incubation at about 20° C. for about 1, 2, 3, 4, 5, 6, 7, 8, 9 or 10 hours to allow for spore germination, a second pressure treatment may be required to further eliminate yeast.

In certain embodiments, the partially fermented sap can be subjected to a second pressure treatment of at least about 4500, about 4600, about 4700, about 4800, about 4900, about 5000, about 5100, about 5200, about 5300, about 5400, about 5500, about 5600, about 5700, about 5800, about 5900, about 6000, about 6100 or about 6200 Bar.

In certain embodiments, the partially fermented sap can be subjected to a second pressure treatment at a temperature of about 4, 5, 6, 7, 8, 9, 10, 12, 13, 14, 15, 16, 17, 18, 19 or 20 degrees Celsius.

In certain embodiments, the partially fermented sap can be subjected to a second pressure treatment of about 4500-6200 Bar.

In certain embodiments, the treated partially fermented sap can be maintained at a constant temperature of about 4, 5, 6, 7, 8, 9, 10, 12, 13, 14, 15, 16, 17, 18, 19 or 20 degrees Celsius. In certain embodiments, the treated partially fermented sap can be maintained at a constant temperature of about 20° C.

In certain embodiments, the partially fermented sap can be subjected to a second pressure treatment for about 30, 60, 90, 120, 150 or 180 seconds.

In certain embodiments, the amount of yeast in the partially fermented sap subjected to a second pressure treatment can be reduced by about 10, 20, 30, 40, 50, 60, 70, 80, 80, 90 or 95%.

In certain embodiments, the partially fermented sap subjected to a second pressure treatment can be supplemented with a flavor, e.g. a fruit juice flavor, is including, but not limited to, strawberry, mango, apple, and/or banana. In certain embodiments, the pressure-treated partially fermented palm sap can be fortified with minerals and/or vitamins.

In certain embodiments, the naturally acidic pH reduces the risk of pathogen growth.

In certain embodiments, the partially fermented sap subjected to the second pressure treatment can have a taste comparable to the freshly collected partially fermented sap prior to any pressurization.

In certain embodiments, the partially fermented sap subjected to the second pressure treatment can be stored at a constant temperature of about 4, 5, 6, 7, 8, 9, 10, 12, 13, 14, 15, 16, 17, 18, 19 or 20 degrees Celsius.

In certain embodiments, the partially fermented sap subjected to the second pressure treatment can be stored for 1, 2, 3, 4, 5, 6, 7, 8, 9, 10, 12, 13, 14, 15, 16, 17, 18, 19, 20, 21, 22, 23, 24, 25, 26, 27, 28, 29 or 30 days or more without adversely affecting taste or any alteration of alcohol content or amount of yeast.

In certain embodiments, the partially fermented sap subjected to the second pressure treatment can be stored at about 4, 5, 6, 7, 8, 9, 10, 12, 13, 14, 15, 16, 17, 18, 19 or 20 degrees Celsius for about 1, 2, 3, 4, 5, 6, 7, 8, 9, 10, 12, 13, 14, 15, 16, 17, 18, 19, 20, 21, 22, 23, 24, 25, 26, 27, 28, 29 or 30 days or more without adversely affecting taste or any alteration of alcohol content or amount of yeast. In certain embodiments, the partially fermented sap subjected to the second pressure treatment can be stored at 20° C. for 1, 2, 3, 4, 5, 6, 7, 8, 9, 10, 12, 13, 14, 15, 16, 17, 18, 19, 20, 21, 22, 23, 24, 25, 26, 27, 28, 29 or 30 days or more without adversely affecting taste or any alteration of alcohol content or amount of yeast.

In certain embodiments, the partially fermented sap subjected to the second pressure treatment cannot contain any preservatives.

In certain embodiments, the partially fermented sap subjected to the second pressure treatment can be filtered to remove bacterial spores.

In certain embodiments, the partially fermented sap subjected to the second pressure treatment cannot be treated with heat or pasteurized.

In certain embodiments, the partially fermented sap beverage is not concentrated.

In certain embodiments, the partially fermented sap beverage does not have carbonation, sweeteners, preservatives, coloring agents, artificial flavors and/or fragrances.

Although this invention has been described with a certain degree of particularity, it is to be understood that the present disclosure has been made only by way of illustration and that numerous changes in the details of construction and arrangement of parts may be resorted to without departing from the spirit and the scope of the invention.

### EXAMPLES

### Example I

### First High Pressure Processing (HPP) Test

Tests were conducted to verify HPP's impact on yeast viability and ways to eradicate spore formation in the yeast.

Upon completing the HPP process using the recommended specifications provided by the HPP machine manufacturer (Hyperbaric 300 model), a near zero level of yeast content was identified. On further research these yeast cells were found to be in haploid state enabling the high pressure to break their cell walls thereby destroying them.

By retaining the toddy at ambient temperature and optimizing nutrient conditions for yeast growth required for sugar fermentation facilitated the elimination of yeast after HPP.

Since yeast multiplies in both haploid and diploid ways, the goal was to retain the yeast state in haploid state to avoid spore formation. APC (Aerobic Plate Count) was also tested to identify other microorganisms. The test was conducted at AVA (Singapore's government test lab), however, AVA's LOD (Limit of Detection) was <100 whereas an LOD of 0 was expected.

TABLE I

| | | | Results |
|---|---|---|---|
| | | | S01-S3-3, S3-4 - |
| S/N | Test | Method | COCONUT WINE |
| 1. | Aerobic Plate | APHA, CMMEF, | 1.0 × 10³ |
| | Count @ | Chapter 7 (2001) | |
| | 35° C. CFU/g | | |
| 2. | Spore Count, | APHA, CMMEF, | <100 |
| | Spores/g | Chapter 22 (2001) | |
| 3. | Yeast Count, | FDA/BAM Chapter | <100 |
| | CFU/g | 18 (2001) | |
| 4. | pH @ 25 C. | FQ-1.1.1 (2014) | 3.21 |

### Example II

### Second High Pressure Processing (HPP) Test

In a second set of tests, more refined tests were conducted to measure the amount of yeast colonies in control and post HPP samples at various pressure/time combinations.

TABLE II

| | | | | Total Yeast and | Total Yeast and |
|---|---|---|---|---|---|
| | | Alcohol | Alcohol | Mold count Day 2 | Mold count Day 9 |
| Code | Specs | Test Day 2 | Test Day 9 | (TUV) | (TUV) |
| SMP 1 | 6000 bar × 90 | | SMP 1 Day 9 | 870 | 20 |
| | secs × 90 secs × | | 5.05% (v/v) | | |
| | 180 secs(after 4 | | | | |
| | hrs) | | | | |
| SMP 2 | 6000 bar × 90 | | SMP 2 Day 9 | 240 | 20 |
| | secs × 90 secs | | 5.06% (v/v) | | |
| SMP 3 | 6000 secs × 180 | | — | | 20 |
| | Secs | | | | |
| SMP 4 | 5000 Secs × 180 | SMP 4 Day 2 | SMP 4 Day 9 | 50 | 10 |
| | Secs | 4.94% (v/v) | 5.07% (v/v) | | |
| Control | no hpp | | Control Day 9 | 280 000 | 340 000 |
| | | | 5.53% (v/v) | | |

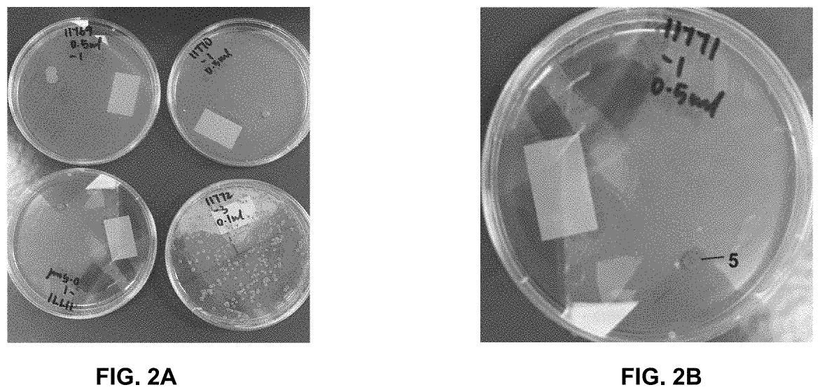

In this test, yeast was isolated and cultured on a Dichloran Rose Bengal Chloramphenicol Agar plate (see FIG. 2). There was a significant difference in the number of colonies between the control and HPP-treated samples. The yeast responsible for the fermentation was identified as Saccharomyces cerevisiae, also known commonly as brewer's yeast.

### Example III

### Spore Formation

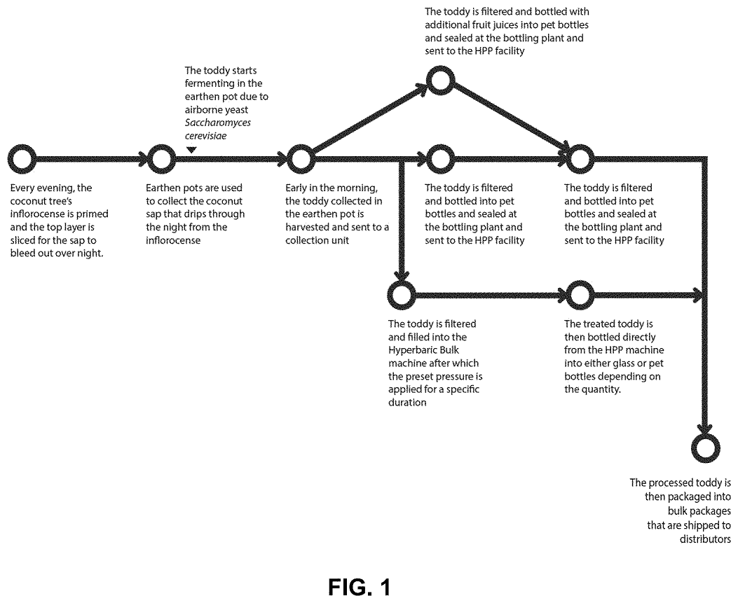

The process for pressure treating partially fermented palm sap is depicted in FIG. 1. Despite, the high pressure, some resilient spores survived the pressure exerted by the HPP technology. To remove any residual yeast, an incubation period was devised to allow the spores to germinate prior to HPP. SMP 1 sample of Table I was pressure-treated followed by a second pressure treatment of 6000 bar×90 secs×90 secs×180 secs (after 4 hrs). The best results were obtained if the palm sap fermentation was arrested before the formation of spores under conditions favoring mitotic rather than meiotic cell division. Additional fruit juices and flavors, such as strawberry, mango, apple, banana, etc, can be added to the alcoholic or non-alcoholic version of the partially fermented palm sap beverage. Its naturally acidic pH reduces the risk of pathogen growth.

### Example IV cl Alcohol Test

TABLE III

| Code | Alcohol Test Day 2 | Alcohol Test Day 9 |
|---|---|---|
| SMP 1 | — | SMP 1 Day 9 5.05% (v/v) |
| SMP 2 | — | SMP 2 Day 9 5.06% (v/v) |
| SMP 3 | — | — |
| SMP 4 | SMP 4 Day 2 4.94% (v/v) | SMP 4 Day 9 5.07% (v/v) |
| Control | — | Control Day 9 5.53% (v/v) |

The alcohol content in SMP 4 was measured on Day 2 (Table 2) and on day 9. The alcohol content changed from 4.94% to a maximum of 5.07% in all the samples that went through HPP whereas in the control sample the alcohol content continued to increase to 5.53% even under refrigeration.

### Example V

### Bacterial and Yeast Count Tests

Different combinations of pressure and duration using the High Pressure Processing were tested (view TABLE 1). In order to identify the right combination, the outcomes for a total bacterial count and yeast count on day 2 and day 9. This test identified any remaining pathogens that might hinder the product's quality.

The tests were conducted at two different labs. One at AVA, Singapore and the other at TUV SUD, Singapore. SMP 4 was selected because it reduced the yeast count the most in comparison to the other samples. The primary goal was to arrest the fermentation by eliminating all viable yeast in the sample. The bacterial presence was then reduced further by membrane filtration systems.

TABLE IV
METHOD OF TEST
a) FDA Bacterial Analytical Manual Online
Chapter 3. “Aerobic Plate Count” (January 2001)
Chapter 18, “Yeasts, Moulds and Mycotoxins” (April 2001)

| | | Not more than 100 000 per g | |
|---|---|---|---|
| | | Not more than 500 000 per g | |
| Sale of Food Act | | (Cooked crab meat, prawns and | |
| (Chapter 283, Section (1) | | shrimps) | |
| Eleventh Schedule | | Not more than 1 million per g (meat) | Not Stipulated |
| “Microbiological Standard For Food” | | Total Aerobic Plate Count, | Total Yeast & Mould |
| Fermented Coconut Wine Drink | | CFU/g | Count, CFU/g |
| SMP 1 | Day 2 | 2 600 | 870 |
| | Day 9 | 3 000 | 20 |
| SMP 2 | Day 2 | 920 | 240 |
| | Day 9 | 2 600 | 20 |
| SMP 4 | Day 2 | 1 300 | 50 |
| | Day 9 | 1 400 | 10 |
| Control | Day 2 | 2 300 000* | 280 000 |
| | Day 9 | 1 800 000* | 340 000 |

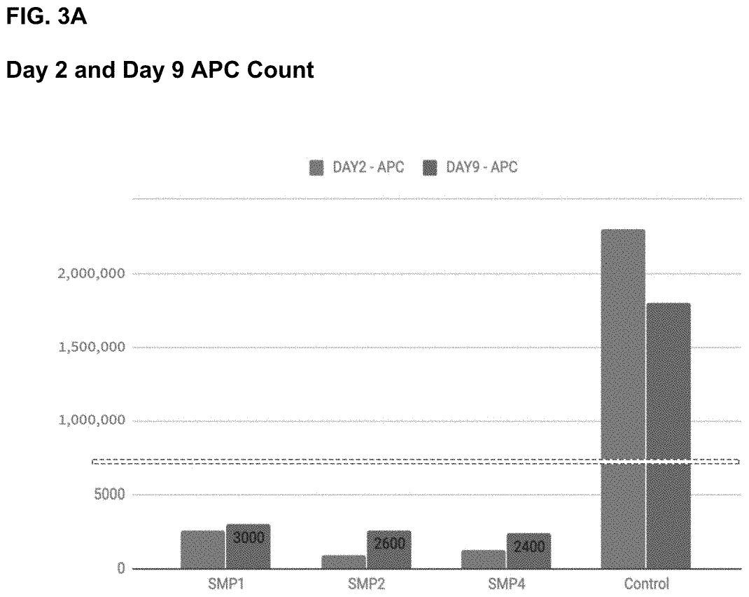

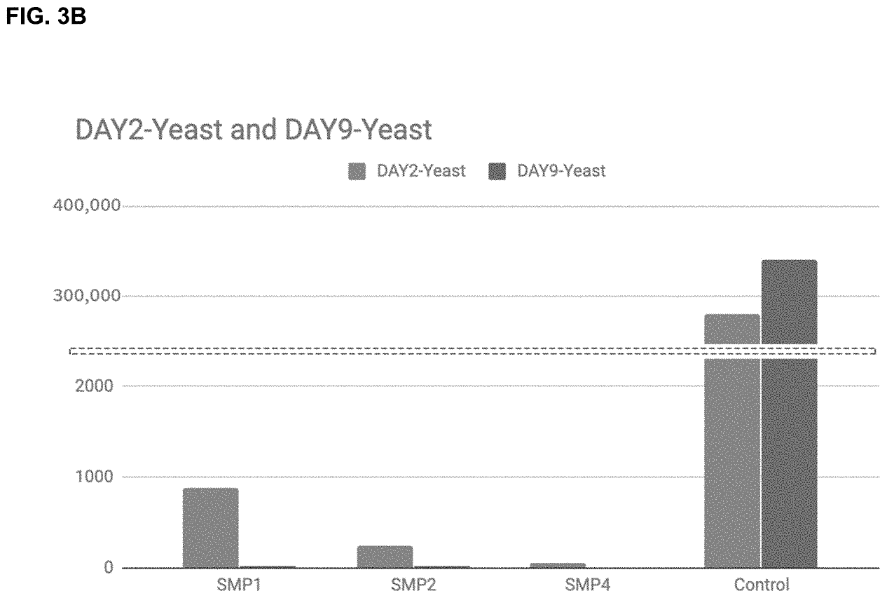

Alternatively similar APC count tests from AVA were conducted by Singapore's government owned and controlled lab to cross verify the data. (see FIG. 3A)

TABLE V

| | | | Results |
|---|---|---|---|
| S/N | Test | Method | S01 - SMP 3 HS |
| 1 | Aerobic Plate | APHA, CMMEF, | 2.4 × 10³ |
| | Count @ | Chapter 7 (2001) | |
| | 35° C., CFU/g | | |
| 2 | Bacillus Count, | FDA/BAM | <100 |
| | CFU/g | Chapter 14 (2001) | |
| 3 | Yeast Count, | FDA/BAM | 2.7 × 10² |
| | CFU/g | Chapter 18 (2001) | |

A sample from the same batch was also tested (SMP 3—see TABLES I-IV). The results corroborated the reports from TUV SUD (see FIG. 3B).

### Example VI

### Bacterial and Yeast Identification Tests

To further identify the reason for the APC count bacterial identification (Bac ID) tests were conducted at TUV SUD because AVA no longer performed Bac ID tests.

TABLE VI
Test Report: 7191199549 - CHM18 - 02 - RC (10 Dec. 2018)

| Sample | | Colony Mornphology on | Cellular | Gram | Catalase | Bacteria |
|---|---|---|---|---|---|---|
| Description | | TSA/SDA | Morphology | Test | Test | Identification |
| SMP 4 | 1 | Irregular, cream colony | 5 μm × 1 μm rods, | Positive | Positive | Paenibacillus |
| Day 9 | | | motile | | | chibensis |
| | 2 | Irregular, cream, matte | >6 μm × 1 μm rods, | Positive | Positive | Bacillus Cereus |
| | | colony | motile | | | |
| | 3 | Irregular, cream-white | 5 μm × 1 μm rods, | Positive | Positive | Lysinibacillus |
| | | colony | non-motile | | | fusiformis |
| | 4 | Round, cream-white colony | 4 μm × 1 μm rods, | Positive | Negative | Paenibacillus |
| | | | motile | | | physcomitrellae |
| | 5 | Round, white colony | Yeast cells were | — | — | Saccharomyces |
| | | | observed | | | cerevisiae |

Method of Test
a) Gram Test, Catalase Test, Colony Morphology and Cellular Morphology was performed according to Method: TTS - CHM - TM - 251/09.
b) Bacteria and fungi colonies were then purified again and subcontracted for identification

Most of the organisms identified were spore forming suggesting the processing toddy would require a filtration system in addition to the HPP. Upon further investigation, “off the shelf” membrane filtration systems were found to be an ideal filtration system for removing spore forming bacteria.

### Example VII

### Tasting Tests

Two sets of HPP tests were evaluated. Post HPP the samples were sent out for lab analysis. Upon receiving the reports from the labs, each sample was tasted and compared with a fresh batch of toddy. In both HPP tests a pressure of 5000 bar was found to give a taste closest to a correctly fermented toddy consumed the same day as it was harvested. Samples subjected to 5000 bar for a duration of 180 secs and 5000 bar at 240 secs were also evaluated. There was no discernable difference in taste between samples treated for either 180 secs or 240 secs. However there was a big difference in the flavor of a toddy treated at 5000 bar as compared to a toddy treated at 6200 bar.

### Example VIII

### Brix Tests

Toddy on day 2 (SMP 1—see TABLE I) after HPP had a Bx of 6.0. Brix tests were conducted to identify the sugar content or soluble solids in a product.

What is claimed is:

1. A pressure-treated, partially fermented palm sap beverage.

2. The beverage of claim 1, wherein the palm sap beverage is stable for at least 9 days at about 20° C.

3. The beverage of claim 1, wherein the palm sap beverage is stable for at least 90 days at about 4° C.

4. The beverage of claim 1, wherein the palm sap beverage comprises a total yeast and mold count of less than about 50 CFU/g.

5. The beverage of claim 1, wherein the palm sap beverage comprises an alcohol content of about 0-9%.

6. The beverage of claim 1, wherein the palm sap beverage comprises an alcohol content of about 4-6%.

7. The beverage of claim 1, wherein the palm sap beverage comprises flower sap from the coconut palm.

8. The beverage of claim 1, wherein the palm sap beverage is subjected to a first pressure treatment of about 4500-6200 Bar at 20° C.

9. The beverage of claim 8, wherein the first pressure-treatment lasts for 180 seconds.

10. The beverage of claim 8, wherein the palm sap is incubated at about 20° C. prior to a second pressure treatment of about 4500-6200 Bar.

11. The beverage of claim 10, wherein the second pressure treatment lasts about 180 seconds.

12. The beverage of claim 1, wherein the palm sap is partially fermented for about 4-6 hours at about 20° C. prior to the first pressure treatment.

13. The beverage of claim 1, wherein the palm sap is not irradiated and/or pasteurized.

14. A beverage consisting of a partially fermented palm sap having an alcohol content of about 5% and a total yeast and mold count of less than about 50 CFU/g.

15. A method of making a palm sap beverage comprising subjecting a partially fermented palm sap to a pressure treatment of more than about 4500-6200 Bar.

16. The method of claim 15, wherein the pressure treatment lasts about 180 seconds.

17. The method of claim 15, wherein, after the pressure treatment, the partially fermented palm sap is incubated at about 20° C.

18. The method of claim 15, wherein the pressure treated partially fermented palm sap is subjected to a second pressure treatment of about 4500-6200 Bar at about 20° C.

19. The method of claim 18, wherein the second pressure treatment lasts about 180 seconds.

20. The method of claim 15, wherein the partially fermented palm sap has an alcohol content of about 0-9%.

21. The method of claim 15, wherein the partially fermented palm sap has an alcohol content of about 4-6%.

22. The method of claim 15, wherein the partially fermented palm sap comprises a total yeast and mold count of less than about 50 CFU/g.

23. The method of anyone of claim 15, wherein the palm sap beverage is stable for at least 9 days at about 20° C.
